(19) United States
(12) Patent Application Publication
(10) Pub. No.: US 2019/0056136 A1
(43) Pub. Date: Feb. 21, 2019

(54) AIR CONDITIONING CONTROL SYSTEM

(71) Applicant: ROOYENBURG PTY LTD, Brisbane (AU)

(72) Inventor: Conrad Adriaan VAN ROOYEN, Brisbane (AU)

(21) Appl. No.: 16/077,617

(22) PCT Filed: Feb. 15, 2017
(86) PCT No.: PCT/AU2017/050130

§ 371 Date: Aug. 13, 2018

(30) Foreign Application Priority Data
Feb. 15, 2016 (AU) 2016900511

(51) Int. Cl. F24F 11/46; G08C 23/04; G05B 15/02; G06Q 50/06; F24F 11/56; F24F 11/63

(52) U.S. Cl. CPC F24F 11/46; G08C 23/04; F24F 11/63; G06Q 50/06; F24F 11/56; G05B 15/02

(57) ABSTRACT

An air conditioning control system and method is provided that may be used to reduce electricity costs associated with use of an existing air conditioner. The system includes: a receiver, for intercepting a first control signal from a user input device intended for an air conditioner; a controller, coupled to the receiver and configured to generate a second control signal according to the first control signal; and a transmitter, for transmitting a second control signal to the air conditioner.

### TECHNICAL FIELD

The present invention relates to control of configurable electrical loads such as air conditioners.

### BACKGROUND ART

Many individuals struggle to control the cost of running air conditioners in summer, and as such, consider their air conditioners to be a luxury or discretionary item. As a result, many people do not use their air conditioners as much as they would like to, for fear of a high electricity bill.

Certain energy meters exist, that enable a user to monitor how much power has been used by an air conditioner. While this in theory enables a user to track energy usage, and adjust their behaviour accordingly, such systems require the user to actively monitor the usage and be in control of the air conditioner, which in many cases is simply not feasible.

Furthermore, electricity companies have problems with high peak demand on hot days, due to heavy air conditioner usage. In particular, even rare users of air conditioners will typically turn them on during the hottest days of the season, making the distribution of use (and thus power consumption) very uneven. Many businesses, schools and shopping centres have over time installed multiple discrete electricity consumption devices such as air conditioners, which are generally controlled using a thermostat. As such, on hot days, it is common for all such devices to be operating simultaneously.

Electrical utility companies have long been looking for ways to reduce the peak loading on their electrical distribution networks. As a result, certain ‘Peak Smart” air conditioners exist, in which utility companies are able to reduce energy consumption of the air conditioner for short periods to reduce peak demand by remote control. In certain circumstances, rebates are offered by utility companies, to encourage users to install such systems.

Such Peak Smart air conditioners are generally attractive for new air conditioner installations, as the rebate generally outweighs the additional cost of the Peak Smart air conditioner over a non-Peak Smart air conditioner. However, it is generally not economically effective for home owners to replace existing air conditioners with Peak Smart air conditioners when the existing air conditioner is still functional. Attempts have been made in the past to convert older, conventional air conditioners to ‘smart’ air conditioners, however such conversion was costly, and thus not cost effective. In particular, electronics either needed to be replaced or modified to enable smart interaction, which is complex given that the electronics varies greatly between different models of older air conditioners.

As such, there is a need for an improved electronic control system.

It will be clearly understood that, if a prior art publication is referred to herein, this reference does not constitute an admission that the publication forms part of the common general knowledge in the art in Australia or in any other country.

### SUMMARY OF INVENTION

The present invention is directed to control system, which may at least partially overcome at least one of the abovementioned disadvantages or provide the consumer with a useful or commercial choice.

With the foregoing in view, the present invention in one form, resides broadly in an air conditioning control system including:

a receiver, for intercepting a first control signal from a user input device;

a controller, coupled to the receiver and configured to generate a second control signal according to the first control signal; and

a transmitter, for transmitting a second control signal to the air conditioner.

Advantageously, the control system is able to be inexpensively used with an existing air conditioning system. The controller is able to manage electricity costs of the air conditioner through generation of the second control signal. As an illustrative example, the controller may selectively prevent the configurable air conditioner from being turned on, or operating above a particular threshold, in order to manage electricity costs.

Preferably, the controller is configured to detect a startup state of the air conditioner, and generate the second control signal according to the first control signal and the startup state. The controller may configure the air conditioner to run at a lower maximum power for an initial period to reduce peak load. As an illustrative example, the controller may configure the air conditioner to run at no more than 80% of its peak rate for the first 60 minutes, rather than running at 100% for the first 30 minutes, reducing the peak rate by 20%.

The controller is configured to detect a temperature control anomaly of the air conditioner, and generate a second control signal according to the first control signal and the temperature control anomaly. For example, the controller may detect that the air conditioner is unable to temperature control an area, based upon a change in temperature in the area. An example of such scenario is when a door or window has been left open, and the temperature in the area is not adjusting according to known rates.

Preferably, the user input device is a remote control.

Preferably, the first and second signals are infrared (IR) signals. The first and second signals may conform to the same protocol.

Preferably, the control system includes a barrier, for blocking reception of the first signal by the air conditioner.

Preferably, the receiver and transmitter are located in proximity to the air conditioner.

Suitably, the second signal is either the first signal, or a zero signal. As such, the controller can selectively forward the first signal to the air conditioner.

Suitably, the first signal may relate to a first configuration of the air conditioner, and the second signal may comprise a second configuration of the air conditioner. The second configuration may correspond to a lower power consumption than the first configuration.

Preferably, the controller is configured to monitor usage of the load, and generate the second signal according to usage. Suitably, the controller is configured to monitor on and off signals sent to the electrical load, and monitor usage at least in part based thereon.

Preferably, the rules include a budget, and usage is compared to the budget. The budget may comprise time based budget.

The budget may comprise a daily, weekly or monthly budget.

Preferably, the controller is further configured to receive a peak load control signal, and generate the second control signal in part based thereon. The peak load control signal may comply with Australian Standard (AS) 4755.

The rules may include maximum or minimum operating parameters.

The rules may include time of day based rules.

The controller may further be configured to control operation of the air conditioner to reduce peak usage.

In another form, the invention resides broadly a method for controlling an air conditioner, the method including:

intercepting, at a receiver, a first control signal from a user input device;

generating, at a controller, a second control signal according to the first control signal; and

transmitting the second control signal to the air conditioner.

In yet another form, the invention resides broadly a method for controlling a configurable electrical load, the method including:

receiving a first control signal from a user input device;

generating a second control signal according to the first control signal and one or more rules; and

transmitting the second control signal to the electrical load.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a control system, according to an embodiment of the present invention;

FIG. 2 illustrates a schematic of the controller of FIG. 1, according to an embodiment of the present invention;

FIG. 3 illustrates a side cross sectional view of a portion of the controller of FIG. 1, in use on an air conditioner; and

FIG. 4 illustrates a method for controlling an electrical load, according to an embodiment of the present invention.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

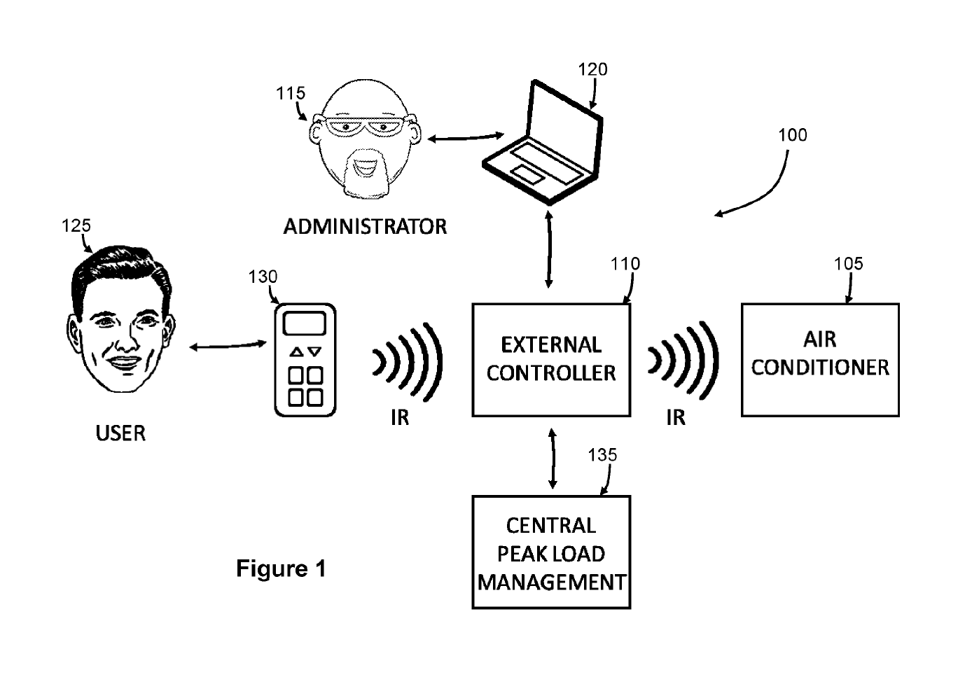

FIG. 1 illustrates a control system 100, according to an embodiment of the present invention. The control system 100 includes an air conditioner 105, the operation of which is controlled by an external controller 110.

Initially, an administrator 115 configures the controller 110 using an administrator device 120 that is coupled to the controller. The administrator may configure a daily, weekly or monthly time budget for the air conditioner, certain hours when the air conditioner 105 may be run, and/or operating parameters, such as maximum or minimum operating temperatures.

The controller 110 then intercepts infrared signals provided by a user 125 using a remote control 130 of the air conditioner 105. In particular, the controller 110 is configured to intercept all signals of the remote control 130 such that it is not possible to turn on or off the air conditioner using the remote control 130 directly.

This may be achieved using an infra red barrier above an infrared sensor of the air conditioner, to block the signals of the remote control, and an infrared emitting device positioned under the barrier, as described below with reference to FIG. 3.

The controller 110 then determines whether the signal should be passed on to the air conditioner 105 or not, and if so whether the signal shall be modified.

As an illustrative example, if the user 125 attempts to turn on the air conditioner 105 when the time budget for the air conditioner has been fully used, the controller 110 intercepts the signal of the remote control 130 without further action. As such, the air conditioner 105 is not turned on.

As the air conditioner cannot be turned on without the controller 110, the controller is able to accurately monitor when, and how long, the air conditioner has been running. For example, the controller may log start and stop times of the air conditioner 105, and also settings in relation to the air conditioner. For example, the controller may monitor settings of the air conditioner (e.g. set and/or ambient temperature, fan speed, etc) together with the operating times.

When the controller 110 determines that the time budget for the air conditioner has been fully used, the controller 110 may turn off the air conditioner. Alternatively, the controller may configure the air conditioner to operate in a low power consumption mode, e.g. at 25° C. rather than 20° C., or using fan only.

As an illustrative example, the signal from the remote control 130 may relate to an on signal, setting the air conditioner to cool to a target temperature of 20° C. The signal from the controller may, however, relate to an on signal, setting the air conditioner to operate at fan only.

The controller 110 may also be coupled to a central load management system 135, such as a load management system of an electricity provider. In such case, the central load management system 135 may monitor a load of a power grid, and submit a request to the controller 110 to turn the air conditioner 105 off, or configure it to operate in a low power consumption mode, at peak periods.

The controller 110 may also be configured to detect a startup state of the air conditioner, and generate the second control signal according to the first control signal and the startup state.

The startup state may correspond to the first time the air conditioner has been started in a time period (e.g. in a day). Alternatively, the startup state may be determined based upon a difference between a desired temperature and an actual temperature when the air conditioner is turned on.

In the startup state, the controller may configure the air conditioner to run at a lower maximum power for an initial period to reduce peak load. As an illustrative example, the controller may configure the air conditioner to run at no more than 80% of its peak rate for the first 60 minutes, rather than running at 100% for the first 30 minutes, reducing the peak rate by 20%.

The controller may be configured to detect a temperature control anomaly of the air conditioner, and generate a second control signal according to the first control signal and the temperature control anomaly. For example, the controller may detect that the air conditioner is unable to temperature control an area, based upon a change in temperature in the area. An example of such scenario is when a door or window has been left open, and the temperature in the area is not adjusting according to known rates.

The controller may monitor temperature changes over time at one or more configurations, and compare an actual temperature change to previously monitored changes to detect the temperature control anomaly.

The controller may monitor usage patters, and pre-cool one or more areas according to the usage pattern. The controller may be configured to pre-cool areas in a staggered manner, or using lower power consumption, to reduce peak power consumption.

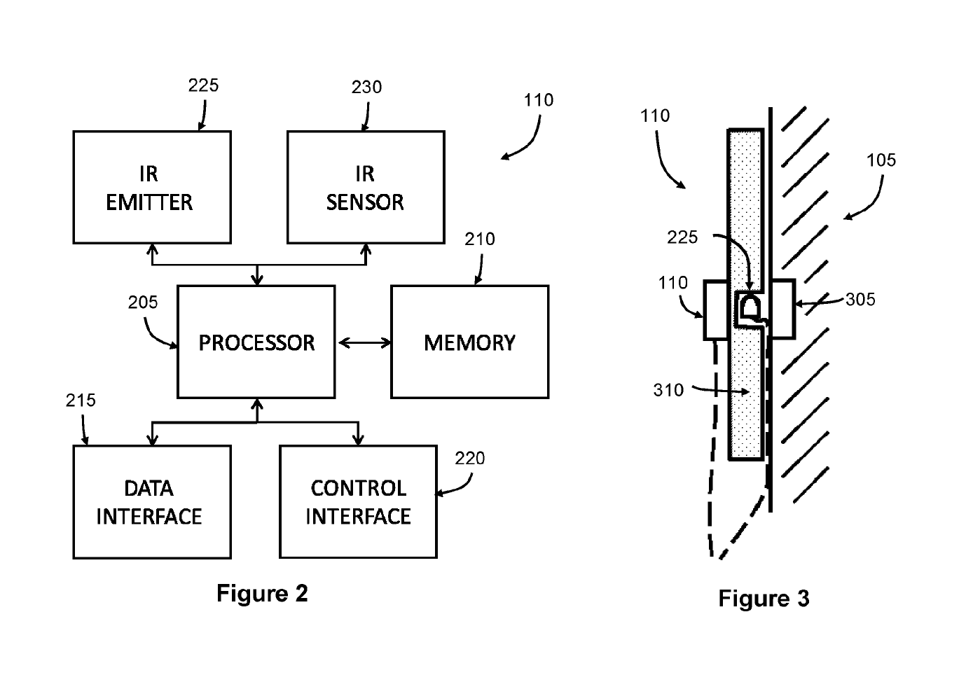

FIG. 2 illustrates a schematic of the controller 110, according to an embodiment of the present invention.

The controller 110 includes a processor 205, and a memory 210 coupled to the processor 205. The memory 210 includes instruction code executable by the processor for monitoring usage, and determining whether a budget has been used.

The controller 110 further includes a data interface 215 and a control interface 220 coupled to the processor 205. The data interface 215 enables the administrator to log into to the controller 110 and input budget data, set usage rules and the like, as outlined above. Similarly, the control interface 220 enables a central load management system 135 to control the system.

As an illustrative example, the data interface 215 may utilise a web-based forms to enable the administrator to configure the controller, and the control interface may comprise an Australian Standard (AS) 4755 Demand Response Interface.

Finally, the controller 110 includes an infra red (IR) emitter 225, such as an IR light emitting diode (LED), and an IR sensor 230, such as an IR receiver diode. The IR sensor 230 captures the signal from the remote control 130, and the IR emitter 225 is able to provide a signal to the air conditioner 105 (which may or may not be a captured signal from the remote control 130).

In some embodiments, the controller 110 includes a temperature sensor, for sensing a temperature of a surrounding area. The temperature sensor may be configured to detect temperature control anomalies (e.g. due to a window or door being left open), or temperature values outside of one or more thresholds, and apply different controls accordingly. For example, if there is a temperature control anomaly, the air conditioner may be configured to operate at a low rate, or not at all, and if unusually hot temperatures are detected, a maximum operating rate of the air conditioner may be temporarily increased.

FIG. 3 illustrates a side cross sectional view of a portion of the controller 110, in use on an air conditioner 105. In use, the IR emitter 225 is placed directly adjacent to an IR sensor 305 of the air conditioner 105 such that when the IR emitter 225 emits an IR signal it can be received by the IR sensor 305 of the air conditioner 105.

An IR shield 310 is then placed directly above the IR sensor 305 of the air conditioner 105 and the IR emitter 225, such that only IR signals from the IR emitter 225 can be received at the IR sensor 305 and all other signals are blocked. The IR shield 310 may comprise an opaque, self adhesive shield that extends over and around the IR sensor 305.

Finally, the IR sensor 230 is placed directly on the IR shield 310, and above the IR sensor 305, such that signals from the remote control can be received when the remote control is used normally.

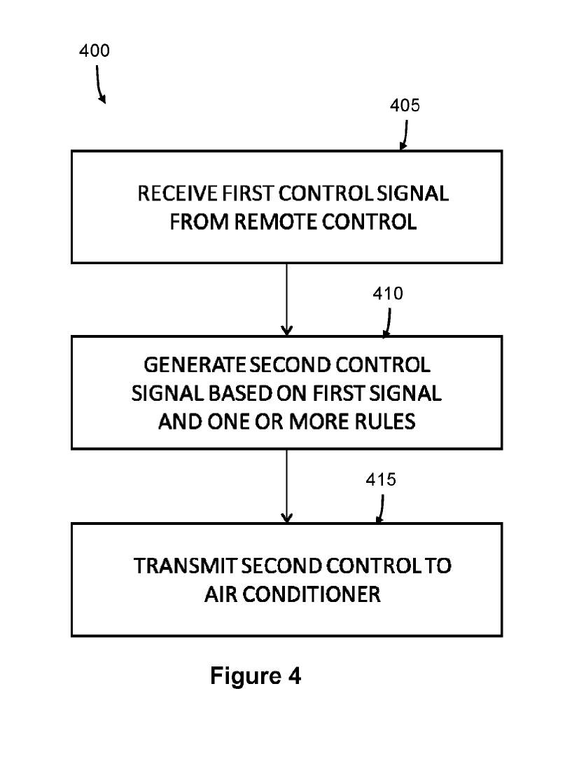

FIG. 4 illustrates a method for controlling an electrical load, according to an embodiment of the present invention.

At step 405, a first control signal is received from the remote control 130. In particular, the user 125 presses a button on the remote control, which causes it to transmit the IR signal.

At step 410, a second control signal is generated by the controller 110 according to the first control signal and one or more rules. As discussed above, the rules can include a budget, or the like.

At step 415, the second control signal is transmitted to the air conditioner 105.

As such, the signal from the remote control is intercepted and replaced by a signal from the remote control. This enables an administrator or third party to control operation of the air conditioner.

According to certain embodiments, the controller may be configured to monitor time of day based usage, and provide weights to usage times depending on time of day. For example, late night operation of the air conditioner (when variable electricity tariffs may be low) may have a lower weight when compared with operation of the air conditioner during peak hours. As such, the user may run the air conditioner longer during the night (or off peak periods) than during peak periods.

According to certain embodiments, the controller may be configured to estimate a load of the air conditioner, and use a load based budget. Load may be estimated based upon any suitable factor, including ambient temperature, set temperature, and the like. As such, usage of the air conditioner may be given a higher weight when load is estimated to be high.

According to certain embodiments, the controller 110 may configure operation of the air conditioner to reduce peak usage. This may be done using knowledge of how utility companies measures and calculate peak demand with reference to demand intervals. In particular, the controller 110 may set and control a duty cycle for the air conditioner for each demand interval with a view of reducing peak demand. As an illustrative example, the controller may delay turning an air conditioner back on until a new demand interval, to avoid certain intervals having higher usage than other intervals.

The controller may also adjust the duty cycle of the air conditioner 105 for a particular demand period based on a duty cycle of a previous demand period, thus enabling the system to “self tune”.

For example, the budget may be increased when the controller determines that the air conditioner is under long term higher load, and vice versa. As an illustrative example, when more people are in the room the demand will be allowed to ramp up slowly to compensate therefore. However, any abrupt changes, such as a door being left opened, are not compensated for, to avoid wasting valuable budget on outside air.

According to certain embodiments, the controller utilises a demand budget for every utility demand period, of which there are typically many of in a day (or a similar corresponding short period). As such, the budget for the air conditioner may be spread out over a day (and/or week or month), avoiding the scenario where an entire budget is utilised early, resulting in the air conditioning not working for the rest of the day, week or month.

By incorporating a budget for a short period, any disruptions in cooling provided by the air conditioner having reached its budget will be spread out over the day (rather than bunched at the end of the day), resulting in a comfortable room temperature all day (rather than a cool room for the first half of the day and a hot room for the second half of the day, for example).

This avoids the equipment being turned off by the controller for periods that will be noticeable by users of the equipment.

According to certain embodiments, the controller 110 may be connected with multiple air conditioners. In such case, the air conditioners may have a common budget, and as such, usage of one air conditioner may influence that ability to use another air conditioner. As such, building wide control of air conditioners can be provided.

According to certain embodiments, the controller 110 may issue commands to the air conditioner 105 without having received a signal from the remote control 130 or otherwise. For example, the controller may determine that the budget associated with the air conditioner has been fully used, and thus issue a power off command to the air conditioner.

The system 100 need not be configured to strictly intercept signals from the remote control. In some cases, e.g. hardwired controllers, this may not be feasible. Instead, the controller may be configured to send an override command shortly after receiving the first command from the user. For example, the signal from the remote control 130 may relate to an on signal, setting the air conditioner to cool to a target temperature of 20° C. After detection of this signal by the controller, the controller may wait a predetermined period (e.g. 1, 2 or 5 seconds), and send a override signal to the air conditioner, setting the air conditioner to operate at fan only.

Advantageously, the system 100 is simple and cost effective to retrofit to existing air conditioners and provides a simple method to set an electricity energy budget for the air conditioner. As such, users are able to use their air conditioner using summer without the risk of receiving an unexpectedly large bill, and organisations are able to effectively manage their electricity usage.

Additionally, utility companies are able to use the system 100 to provide low cost ways to get customers onto demand response programs, which can help them target problem suburbs and control larger numbers of high load devices.

While the above has been described with reference to air conditioners, the skilled addressee will readily appreciate that other types of devices may be controlled, including heaters, or any other suitable device.

Similarly, while the administrator 115 and user 125 are illustrated as being separate individuals, the skilled addressee will readily appreciate that the user 125 may also take on the roll as administrator 115, to control their own usage.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. An air conditioning control system including:
a receiver, configured to intercept a first control signal from a user input device intended for an air conditioner;
a controller, coupled to the receiver and configured to generate a second control signal according to the first control signal; and
a transmitter, for transmitting a second control signal to the air conditioner.

2. The air conditioning control system of claim 1, wherein the controller is configured to detect a startup state of the air conditioner, and generate the second control signal according to the first control signal and the startup state.

3. The air conditioning control system of claim 1, wherein the controller is configured to detect a temperature control anomaly of the air conditioner, and generate a second control signal according to the first control signal and the temperature control anomaly.

4. The air conditioning control system of claim 1, wherein the user input device is a remote control.

5. The air conditioning control system of claim 1, wherein the first and second signals are infrared (IR) signals.

6. The air conditioning control system of claim 1, wherein the first and second signals conform to the same protocol.

7. The air conditioning control system of claim 1, further including a barrier, for blocking reception of the first signal by the air conditioner.

8. (canceled)

9. The air conditioning control system of claim 1, wherein the second signal is either the first signal, or a zero signal, enabling the controller to selectively forward the first signal to the air conditioner.

10. The air conditioning control system of claim 1, wherein the first signal relates to a first configuration of the air conditioner, and the second signal comprises a second configuration of the air conditioner, and wherein the second configuration corresponds to a lower power consumption than the first configuration.

11. The air conditioning control system of claim 1, wherein the controller is configured to monitor usage of the air conditioner, and generate the second signal according to the monitored usage.

12. The air conditioning control system of claim 11, wherein the controller is configured to monitor on and off signals sent to the air conditioner, and monitor usage at least in part based thereon.

13. The air conditioning control system of claim 11, wherein the usage is compared to a budget, and the second signal is generated according to usage with reference to the budget.

14. The air conditioning control system of claim 13, wherein the budget comprises a time based budget.

15. The air conditioning control system of claim 14, wherein the budget comprises a daily, weekly or monthly budget.

16. The air conditioning control system of claim 1, wherein the controller is further configured to receive a peak load control signal, and generate the second control signal in part based thereon.

17. (canceled)

18. The air conditioning control system of claim 1, wherein the controller includes one or more rules, and wherein the second control signal is generated according to the first control signal and the one or more rules.

19. The air conditioning control system of claim 18, wherein the rules include maximum or minimum operating parameters.

20. The air conditioning control system of claim 18, wherein the rules include time of day based rules.

21. (canceled)

22. A method for controlling an air conditioner, the method including:
intercepting, at a receiver, a first control signal from a user input device intended for an air conditioner;
generating, at a controller, a second control signal according to the first control signal; and
transmitting the second control signal to the air conditioner.

23. A method for controlling an electrical load, the method including:
receiving a first control signal from a user input device intended for an electrical load;
generating a second control signal according to the first control signal and one or more rules; and
transmitting the second control signal to the electrical load.
